(19) United States
(12) Patent Application Publication
(10) Pub. No.: US 2004/0125239 A1
(43) Pub. Date: Jul. 1, 2004

(54) Television tuner supporting channel hopping

(76) Inventors: David Rahn, Kanata (CA); Stefan Fulga, Great Dunmow (GB); Brian Robar, Bishops Stortford (GB); Walter Bax, Nepean (CA)

Correspondence Address: KENYON & KENYON, 1500 K STREET, N.W., SUITE 700, WASHINGTON, DC, 20005, US

(21) Appl. No.: 10/328,140

(22) Filed: Dec. 26, 2002

(51) Int. Cl. H04N 5/50

(52) U.S. Cl. 348/731

(57) ABSTRACT

Televisions, especially HDTV, require tremendous bandwidth, however a time interval to switch communication channels may result in the loss of several image frames or a large portion of a single image frame. Unfortunately, small glitches in television signals are not tolerable since this affects the quality of the entertainment. Thus, wireless television tuners are unacceptable to most users because of frequency of glitches occurring as a result of channel hopping. A novel wireless television tuner system is thus disclosed that switches—hops—between frequency channels for transmitting television data to the wireless television tuner. The novel tuner uses a fractional-N (FRAC-N) synthesizer with an improved settling time in order to reduce potential glitches occurring as a result of the channel hopping.

### FIELD OF THE INVENTION

The invention relates generally to television tuners and more particularly to a television tuner incorporating a synthesizer allowing more rapid settling time.

### BACKGROUND OF THE INVENTION

In the world today, communication is one of the most significant luxuries. People in affluent countries have voice communication systems, data communication systems, and television systems.

Unfortunately, for each communication medium, dedicated wiring is typically required. For example, television wires are usually run within a house in the form of 75 Ohm coaxial cabling. Telephone wires are twisted pair wires. Data communication often requires Ethernet cabling and so forth. For new homes, the wiring is often done before the walls are finished. This provides adequate communication ports in each room. Unfortunately, the communication ports are often in inconvenient locations. Also, for an older home, in order to support more modern forms of communication wiring is required.

Another approach currently being explored for providing communication services within a house or building employs wireless transmission of data signals. Telephone signals, television signals, Internet signals and so forth can be easily transmitted at high data rates throughout a small area. This alleviates any need for wiring and, more importantly, retains a level of freedom and flexibility to home design and decoration.

Clearly, with the advent of wireless communication, much of what we consider technologically proven will no longer be the case. For example, television sets will change. If television channels are available throughout a house via a wireless connection, other homes in the area and other communication signals will provide a challenge in terms of interference and signal to noise ratios. Cordless telephones experienced this problem as they became more widely accepted and, today, telephones are provided with tens of communication channels for providing the voice data signal and a best channel is preferably the one chosen.

During a single telephone communication, a wireless telephone may switch between several different communication channels to ensure continuity of quality of voice communication. Because voice communication data rates are relatively slow, the time to switch communication channels is either not noticeable or is well tolerated by users.

For televisions, the problem is different. Televisions, especially HDTV, require tremendous bandwidth. The interval to switch communication channels may result in the loss of several image frames or a large portion of a single image frame. Whereas people will tolerate small pauses in voice communication, they will not happily tolerate glitches in television signals since this affects the quality of the entertainment. Thus, wireless television tuners are unacceptable to most users because of frequency of glitches occurring as a result of channel hopping.

Therefore, there is a pressing need for a television tuner that can support communication signals at multiple frequencies with fast switching between the signals.

### OBJECT OF THE INVENTION

It is an object of the present invention to provide a television tuner that can support communication signals at multiple frequencies with fast switching between signals at different frequencies.

### SUMMARY OF THE INVENTION

In accordance with the invention there is provided a front end tuner for receiving modulated signals and selecting therefrom modulated signals in accordance with a frequency characteristic thereof and providing an output signal including information representative of said selected signals, comprising: a frequency conversion circuit including a mixer for beating a local oscillator signal with signals within a predetermined band of frequencies to generate signals having frequencies within a predetermined channel band of frequencies and being representative of said selected signals, characterized in that the local oscillator signal is generated using a phased locked loop having a fractional-N synthesizer therein.

In accordance with the invention there is provided a method of tuning a television signal comprising the steps of:

providing a local oscillator for providing a first oscillating signal;

providing a reference oscillator for providing a reference oscillating signal, the reference

oscillator other than an integer factor of the local oscillator frequency;

adjusting the local oscillator relative to the reference oscillating signal by the steps of:

a. comparing an edge of a division of the first oscillating signal, the division other than an integer N division to the reference oscillating signal edge to provide a difference signal,

b. adjusting the local oscillator in dependence upon the difference signal until the first oscillating signal is locked at a frequency other than an integer multiple of the reference oscillating signal;

providing the first oscillating signal to a mixer; and,

providing the television signal to the mixer for beating with the first oscillating signal to produce a mixed signal.

### BRIEF DESCRIPTION OF THE DRAWINGS

The invention will now be described with reference to the attached drawings in which:

FIG. 1 is a simplified block diagram of a prior art home wireless communication system;

FIG. 2 is a simplified block diagram of a prior art home wireless communication system shown in two adjacent homes;

FIG. 3 is a simplified block diagram of a similar prior art home wireless communication system communicating with any of a plurality of frequency channels;

FIG. 4 is a simplified flow diagram of a method of implementing communication using the wireless communication system of FIG. 3;

FIG. 5 is a simplified block diagram of a home wireless communication system comprising a base station in communication with a wireless TV receiver;

FIG. 6 is a simplified block diagram of a FRAC-N synthesizer;

FIG. 7 is a simplified block diagram of a television tuner circuit according to the invention including the FRAC-N synthesizer circuit; and,

FIG. 8 is a simplified flow diagram of a method of implementing a FRAC-N synthesizer.

### DETAILED DESCRIPTION OF THE INVENTION

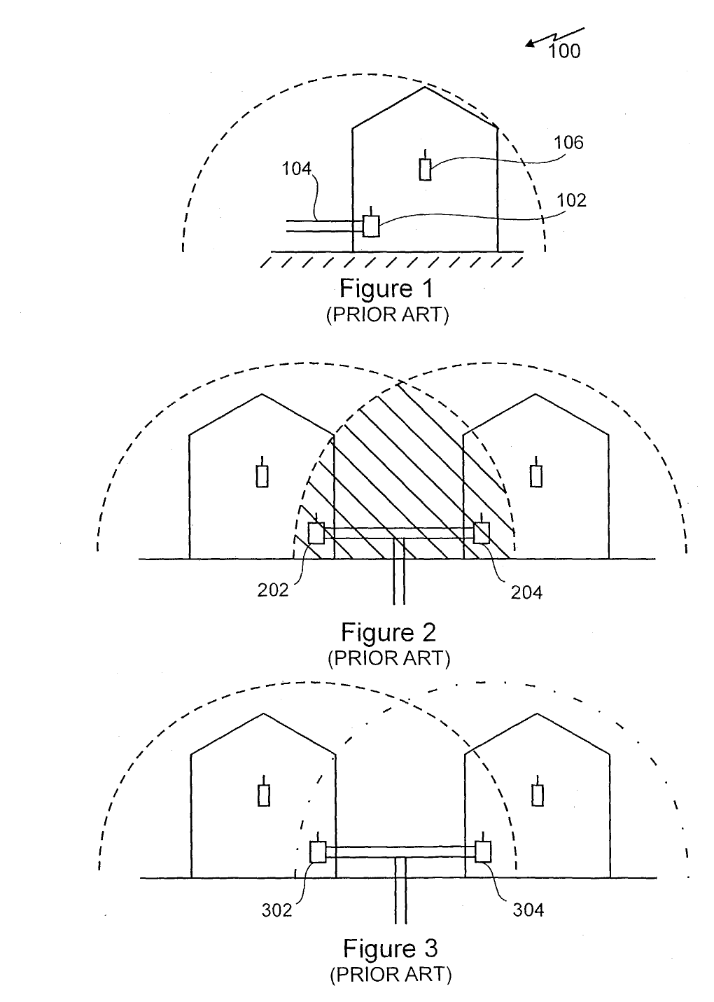

Referring to FIG. 1, shown is a simplified block diagram of a home wireless communication system 100 for supporting telephone communication. A base station 102 is wired into a telephone signal wire 104 carrying a phone signal from a central office to a home. The receiver is in communication via radio frequency (RF) signals with a telephone handset 106 carried by an individual within or about the home. Here, the base station communicates using a fixed RF frequency channel. Anywhere within or about the home within range of the RF signal of the base station, indicated by a circle, the handset is functional for receiving voice data and for transmitting same. The base station and receiver shown both support digital data communication for ensuring sound quality in either direction.

Referring to FIG. 2, a similar home wireless communication system is shown in two adjacent homes. Here, circles about the base stations 202, 204 identify their range. As is evident, there are significant areas of interference between the two base stations and where a handset may, inadvertently, communicate via an incorrect base station. This is problematic.

Referring to FIG. 3, a similar home wireless communication system to that of FIG. 1 is shown, but here the base station 302, 304 and the handset operate to communicate within any of a plurality of frequency channels. As is evident, even when two such wireless communication systems are adjacent one another, they can operate without interference on different communication channels.

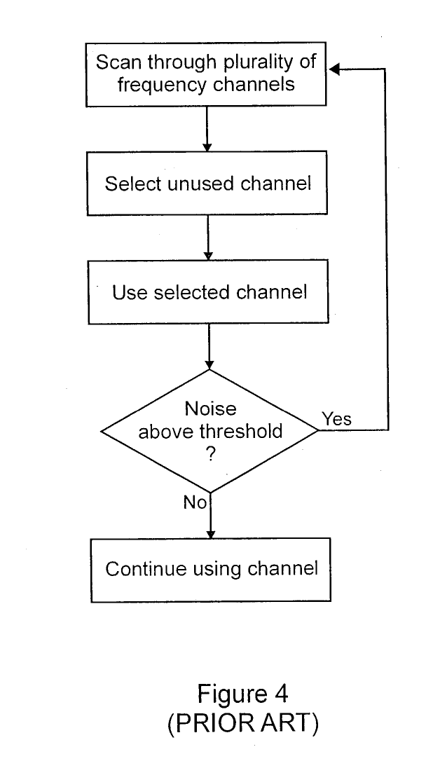

Referring to FIG. 4, a method of implementing communication using the wireless communication system of FIG. 3 is shown. A communication is initiated with a scan through the plurality of frequency channels to detect other communications. When available, a channel that is completely undetected is selected. This channel remains in use until an amount of noise above a given threshold is detected and then the communication system switches—hops—between frequency channels. Because of the nature of channel hopping, this activity is commonly detectable since a momentary silence or lack of voice data occurs. Of course, as long as the silence is short, such an event does not significantly affect communication quality or content. For voice communication 0.1 s is typically considered short.

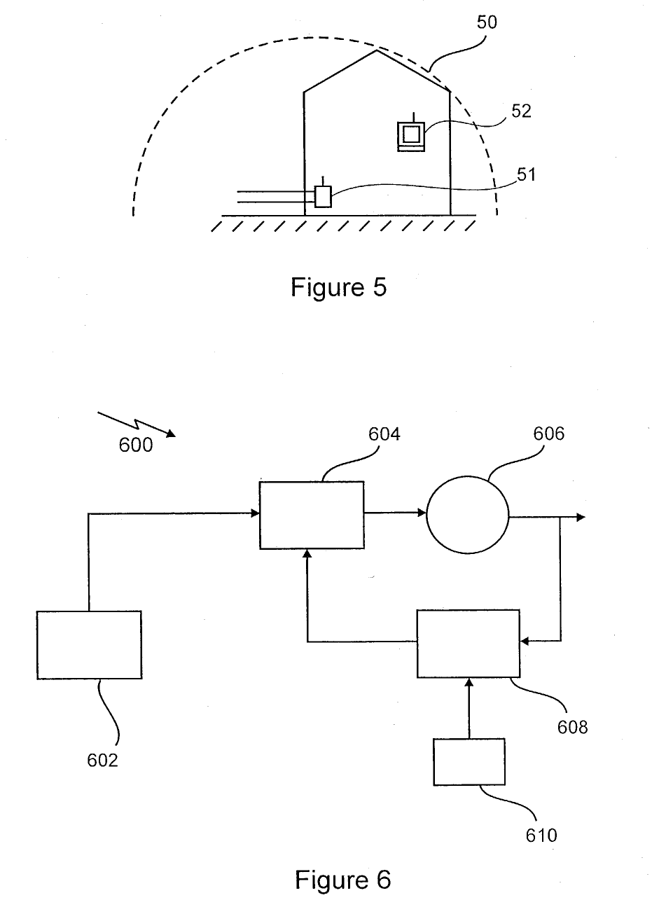

Referring to FIG. 5, a wireless communication system 50 is shown wherein a base station 51 is in communication with a wireless television receiver 52. The base station is provided with the same features as the base station 302 but the data transmission rate is much higher. For example for HDTV, over 60 Megapixels are transmitted each second. This is much higher than the 64 Kilobits of data used to transmit voice data and is likely 4 or more orders of magnitude greater. With this increased bandwidth comes significant problems. For example, whereas the system of FIG. 3 has 0.1 s in which to channel hop—losing 6.4 KBits of data, the wireless television transmitter has only 0.00001 s or less to do the same. Also, though a small silence does not greatly affect conversation, a significantly distorted image will affect viewing and, as such, even 6.4 Kbits of data corresponding to approximately 640 pixels is noticeable and undesirable.

One approach to overcoming this problem is to fix frequency channels for the receiver and the base station. Unfortunately, past experience has brought to light that such an approach is limited and therefore undesirable as discussed with reference to FIG. 2.

Another approach to overcoming this problem is to design a television tuner having a rapid settling time to support very fast channel hopping. In designing a phase lock loop circuit, the settling time is a time in which the loop is not yet locked on a new reference time source. During this time, data extracted from received signals is questionably correct. Typically, until the settling time is passed, data integrity is suspect and data sampling is not performed. As such, a settling time in the order of several screen pixel data values is desired for television communication channel switching. This requires very high speed switching. For example, HDTV has approximately 1 million data points per screen times 60 screens per second. This is 60 million data points a second requiring a settling time in the order of 1/30,000,000 of a second.

Conventional phase locked loop devices operating at the frequencies of television signals and supporting the bandwidth required cannot support this settling time. The settling time is inversely proportional to the bandwidth of the loop filter. Thus, a narrow band loop filter results in increased settling time and a wider band loop filter results in potentially shorter settling times. It is proposed that in order to reduce settling time within the loop, the loop filter is widened in the phase locked loop device.

Unfortunately, in order to widen the loop filter for the phase locked loop device using conventional phase lock loop technology requires a difficult frequency plan selection step which may even prove impossible. Using lower frequency reference signals requires a narrow band loop filter but allows for many frequencies to be even multiples of the lower frequency reference. For example, if the reference is 250 KHz, then any frequency at one quarter, one half, three quarters or an even MHz is an even multiple of the reference frequency. Thus, a lower frequency reference is advantageous for use in tuner design. However, these advantages also prevent channel hopping from being performed rapidly in these same tuners.

In order to widen the bandwidth of the loop filter, the reference frequency must be increased. In order to achieve this, either the frequency plan must support this increased reference frequency which is unlikely or a synthesizer supporting fractional divisions of clock signals is necessary. Such a synthesizer is a FRAC-N synthesizer which is used according to the invention to facilitate frequency plan design and to allow for locking of the phase locked loop to the higher frequency reference oscillating signal. This allows the television tuner to channel hop with shorter settling times and therefore permits operation of a wireless television tuner based system analogous to a wireless telephone communication system commonly available.

Referring to FIG. 6, a block diagram of a FRAC-N synthesizer 600 is presented. A reference frequency f_{R} provided by reference oscillator 602 drives phase/frequency detector 604. The phase/frequency detector 604 provides a voltage to voltage controlled oscillator (VCO) 606 providing an output frequency f_{O} in dependence thereupon. The output frequency f_{O} is coupled via FRAC-N divider 608 to the phase/frequency detector 604 providing a feedback signal to the phase/frequency detector 604. The FRAC-N divider 608 comprises two counters enabling the divider to switch from divide by integer N to divide by N+1 in dependence upon a control signal provided by controller 610. The output frequency f_{O} is stepped in x/m fractions of the reference frequency f_{R}. This is realized, for example, by dividing by N+1 every m cycles and by dividing by N the other cycles resulting in an effective fractional ratio RFRAC=f_{O}/f_{R}=N+x/m, where x=0, 1, 2, . . . , m−1. Of course more complex control is also possible as is other forms of fractional frequency division when desired.

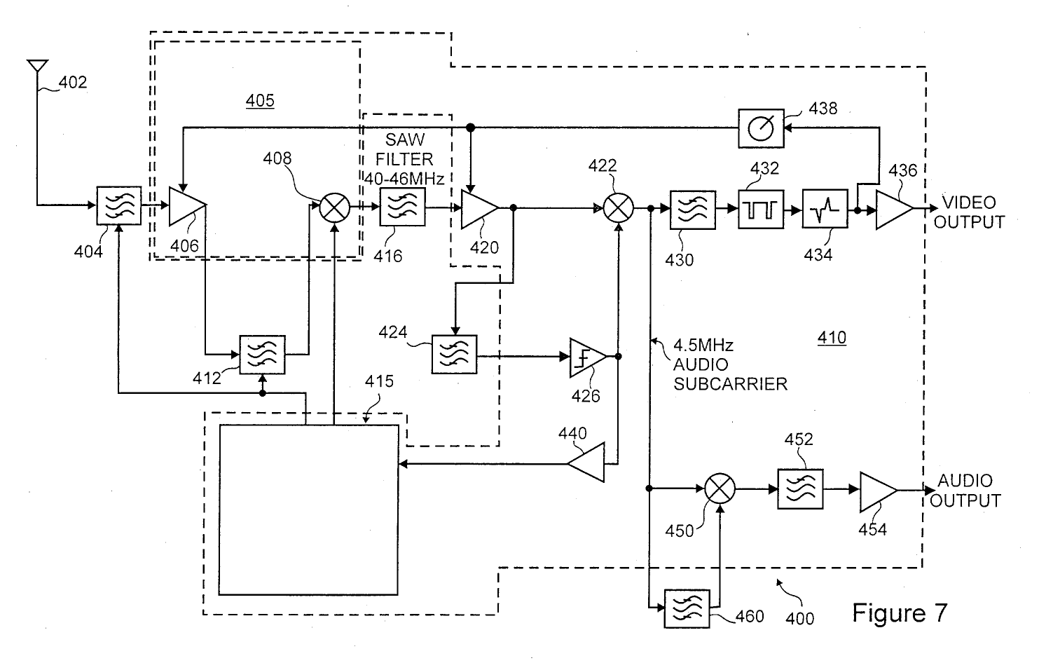

Referring to FIG. 7, a block diagram of a wireless television tuner circuit including the FRAC-N synthesizer circuit is shown. Here, a conventional synthesizer is replaced with a FRAC-N synthesizer. The loop filter is then widened to allow for improved settling time. The wireless receiver is for receiving the entire bandwidth of a cable television signal about a known carrier channel.

Television tuner 400 receives the wireless television RF signal from antenna 402 through bandpass and image reject notch filter 404. Bandpass and image reject notch filter 404 limits the signals entering TV tuner 400 so that a minimum number of undesired signals propagate within TV tuner 400. Filter 404 attenuates signals not in the television signal range about the known carrier frequency. Typically, known interference signals, such as FM broadcast, shortwave service signals, signals in the intermediate frequency band and Citizen Band radio signals, are specifically rejected by filter 404.

Preamplifier 406 and mixer 405 receives the output of bandpass and image reject notch filter 404 and raises the signal level (10 dB) with minimum increase in the noise level (typically 8-10 dB). The gain of preamplifier 406 is controlled by automatic gain control (AGC) 438, so that when a very strong signal enters TV tuner 400, overall gain is reduced, resulting in less distortion in the preamplifier than without the gain reduction.

The output of preamplifier 406 is sent to bandpass and image reject notch filter 412, with the same basic requirement of minimizing the passage of potential interference signals. Filter 412 is external to preamplifier and mixer 405 and is comprised of a plurality of discrete elements, including capacitors, inductors and varactor diodes.

The output of bandpass and image reject notch filter 412 is then sent back to mixer 408 in preamplifier and mixer 405. Mixer 408 mixes the output of filter 412 with the output of a local oscillator, FRAC-N synthesizer 415, which has a frequency chosen to be higher than the desired receiver carrier by 43.75 MHz. Thus, the output of mixer 408 is 43.75 MHz to be compatible with present television systems. There also is an image signal due to mixer 408 at 91.5 MHz above the input frequency, which is removed by filter 404 and filter 412.

FRAC-N synthesizer 415 receives an input frequency reference signal and outputs the status signals AUTOMATIC FREQUENCY CONTROL (AFC) ERROR and FREQUENCY (FREQ) LOCK. Within the FRAC-N synthesizer, is a loop filter to ensure loop stability. Because the reference signal frequency is optionally very similar to the synthesized frequency, the loop filter supports rapid settling time. A local oscillator signal is output from FRAC-N synthesizer 415 to mixer 408.

The 43.75 MHz output signal of mixer 408 then passes through SAW (surface acoustic wave) filter 416, which limits the bandwidth of the signal to only one (1) channel (6 MHz for NTSC standard) and applies a linear attenuation in frequency known as the Nyquist slope around the visual carrier frequency. The linear attenuation by SAW filter 416 converts the signal from a vestigial sideband signal to one which is equivalent to a single sideband with a carrier, so that the frequency response of the signal after demodulation is flat over the video bandwidth. SAW filter 416 is very “lossy” (on the order of 25 dB), so the input to SAW filter 416 is amplified by a preamplifier (not shown) by a corresponding amount to minimize noise effects.

The output of SAW filter 416 is input to intermediate frequency (IF) amplifier 420 in IF and baseband signal processor 410. IF amplifier 420 provides most of the overall gain of TV tuner 400 and receives gain control from AGC 448.

The output of IF amplifier 420 is sent to video detector 422 and is also sent to video carrier filter 424. This is the stage at which video demodulation is performed. Video detector 422 is essentially a mixer with the local oscillator input connected to the output of video carrier filter 424 through carrier amplitude limiter 426. The output of the carrier limiter 426 is an in-phase representation of the video carrier signal without any modulation applied to it. The output of carrier limiter 426 is received by video detector 422, which mixes the output of carrier limiter 426 with the output of IF amplifier 420.

AFC frequency discriminator 440 is used in the prior art device to detect the difference between the carrier frequency contained in the output of carrier limiter 426 and a known valid carrier frequency reference. The output signal on the output of AFC frequency discriminator 440 is an error signal that is used to drive FRAC-N synthesizer 415 in a direction for reducing the error between the output of carrier limiter 426 and the known valid carrier frequency reference. The output of the video detector 422 is a baseband video signal combined with several high frequency mixing artifacts. These artifacts are removed by a video baseband filter 430. The output of video baseband filter 430 is fed to synchronization pulse clamp (sync clamp) 432, which sets the level of the sync pulses to a standard level.

Next, the output of sync clamp 432 is sent to noise invertor 434, which removes large noise spikes from the signal. The output of noise invertor 434 is sent to video buffer 436, which is configured to drive fairly high circuit board impedances of approximately 1000 to 2000 ohms.

The output of noise invertor 434 is also sent to AGC (automatic gain control) 438, which compares the level of the synchronization pulses to the signal blanking level to measure the incoming signal strength and generates a gain control signal which is used by IF amplifier 420 and RF preamplifier 406 to dynamically adjust the gain of the TV tuner 400 for the correct level at the final output port.

The audio signal is an FM signal that follows the same path as the video through video detector 422. At the output of video detector 422, the audio signal appears as a subcarrier at 4.5 MHz, due to the fact that the audio signal comes into prior art TV tuner 400 4.5 MHz higher in frequency than the desired video carrier. The audio subcarrier is passed on to an FM quadrature demodulator. The FM quadrature demodulator is comprised of a mixer, audio second detector 450, and a 90-degree (at 4.5 MHz) phase shifter, audio carrier phase shifter 460. The output of the audio second detector 450 is a baseband audio signal, which is filtered by lowpass (30 kHz) filter 452 to remove any undesired high frequency components. The output of lowpass filter 452 is finally passed on to audio buffer 454 that drives an audio amplifier that ultimately drives a speaker. Serial digital interface 444 receives SERIAL DATA and SERIAL CLOCK inputs to provide control and update status for the television receiver.

Of course, other forms of RF signal tuners for use with television signals are also supported when the synthesizer therein is replaced with a FRAC-N synthesizer as disclosed herein.

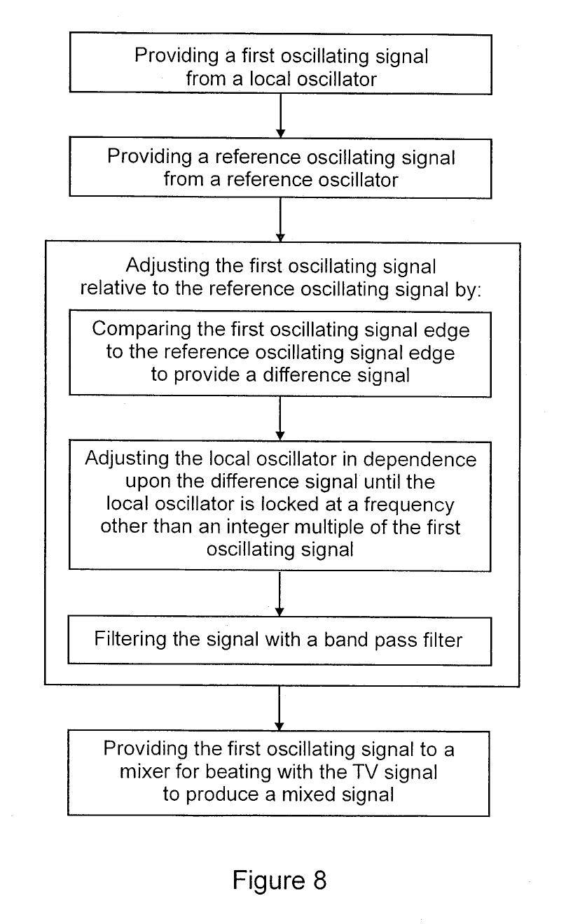

Referring to FIG. 8, a simplified flow diagram of a method of implementing a FRAC-N synthesizer is shown. In a typical arithmetically locked loop, a reference frequency signal and another signal are locked using a simple mathematical relationship based on a single counter. For example, if a first reference clock is at 8 KHz and a second clock is at 16 KHz, then a simple counter to count to two is gated by the 16 KHz clock allowing its output clock edge—every two—to be compared with the 8 KHz clock edge. Thus, the 16 KHz clock is locked to the 8 KHz clock. Same or opposite edge locking is achievable depending on design requirements.

With a FRAC-N synthesizer, a dithering approach is used to clock synchronization. For example, if a 20 MHz clock is to be locked with an 8 MHz clock, this is achieved by alternately locking on a count of two and three. Thus a divider of 2.5 is achieved which is the ratio between the clock frequencies. Further advantageously, such a circuit allows for support of several different clock frequencies when designed accordingly. For example, a single synthesizer could be implemented to support locking of a 20 MHz, 24 MHz, and 28 MHz signal to an 8 MHz reference merely by changing the alternating count amounts between (2, 3), (3, 3), and (3, 4).

Though using the above frequencies the synthesizer seems simple, it is more typically the case that frequencies vary more significantly from a simple 3:2 ratio. For example, a 1 MHz reference signal could be used to lock a 43.56 MHz signal using a counter of (43.44) alternating 56 times out of one hundred on the 44 count and 44 times out of 100 on the 43 count. Thus, very accurate and specific clock locking is achievable.

In the flow diagram of FIG. 8, a reference clock is provided, its rising edge is used to lock to. A second other clock signal is provided by a VCO. The clock signal is used to strobe a counter and thereby count to a predetermined number. When the number is reached, a comparator indicates this and the rising edge of the comparator signal is compared with the rising edge of the reference clock. The VCO is provided a signal in dependence thereon to adjust a phase of the second other clock signal.

While the VCO is being adjusted, a new value is provided to the comparator and the counter is reset. The entire process repeats itself.

The method for providing the new value also repeats itself, here it shown repeating itself after N iterations. In the above examples N was described as 2 and N was described as 100. Of course, N could be any number and even when N is two, four iterations or six iterations are optionally employed. Of course, though the term repeats itself is used, the pattern of repetition may be complex. For example, in the above example of 43.56 MHz, locked to a one MHz reference signal, the pattern will adjust for 56/44 counts which could repeat every 100 clock adjust operations or, in this case 56:44 is reduceable to 14:11 requiring 25 counts before a repetition of the cycle.

Once the FRAC-N synthesizer is implemented accordingly, the loop filter is widened to provide a desired settling time to support channel hopping in a wireless implementation of the television tuner. Of course, the FRAC-N synthesizer may also have other significant advantages when used in a television tuner circuit.

Since the settling time of the loop is inversely proportional to the bandwidth of the loop filter, such an implementation allows for greatly reduced settling times and thereby supports dynamic frequency hopping for signals received at the television tuner of the invention.

Accordingly, by using a Frac-N synthesizer for a phase locked loop, the invention supports faster channel hopping in, for example, a wireless communication system allowing for multichannel wireless television communication within a home that does not interfere with similar systems in adjoining homes or buildings. Of course, the invention also supports truly mobile television sets such as Sony® Watchman® televisions should they be equipped with a receiver for wireless HDTV signal broadcasts from a base station. With the mobile sets, the advantages in fast channel hopping become even more present and urgently needed. Of course, there may be numerous other applications for the television tuner device described hereinabove.

Numerous other embodiments may be envisaged without departing from the spirit or scope of the invention.

What is claimed is:

1. A method of tuning a television signal comprising the steps of:
providing a local oscillator for providing a first oscillating signal;
providing a reference oscillator for providing a reference oscillating signal, the reference oscillator other than an integer factor of the local oscillator frequency;
adjusting the local oscillator relative to the reference oscillating signal by the steps of:
comparing an edge of a division of the first oscillating signal, the division other than an integer N division to the reference oscillating signal edge to provide a difference signal,
adjusting the local oscillator in dependence upon the difference signal until the first oscillating signal is locked at a frequency other than an integer multiple of the reference oscillating signal;
providing the first oscillating signal to a mixer; and,
providing the television signal to the mixer for beating with the first oscillating signal to produce a mixed signal.

2. A method of tuning a television signal as defined in claim 1, wherein the local oscillator is locked in a settling time of less than a time required to display 500 pixels of image data.

3. A front end tuner for receiving modulated signals and selecting therefrom modulated signals in accordance with a frequency characteristic thereof and providing an output signal including information representative of said selected signals, comprising:
a frequency conversion circuit including a mixer for beating a local oscillator signal with signals within a predetermined band of frequencies to generate signals having frequencies within a predetermined channel band of frequencies and being representative of said selected signals,
characterized in that the local oscillator signal is generated using a phased locked loop having a fractional-N synthesizer therein.

4. A front end tuner as defined in claim 3, comprising a loop filter interposed in the phased locked loop for providing stability to the loop.

5. A front end tuner as defined in claim 4, wherein the predetermined channel band of frequencies has a bandwidth between 350 Hz and 3 GHz.

6. A front end tuner as defined in claim 5, wherein the loop filter has bandwidth between 40 kHz and 1 MHz.

7. A front end tuner as defined in claim 6, wherein the loop filter has bandwidth between 50 kHz and 100 kHz.

8. A front end tuner as defined in claim 7, wherein a settling time for locking the loop is less than a time required to display 800 pixels of image data.

9. A front end tuner as defined in claim 3, wherein modulated signals are TV signals.

10. A front end tuner as defined in claim 9, wherein a settling time for locking the loop is of the order of 0.001 s.

11. A front end tuner as defined in claim 3, wherein said phased locked loop is integrated on a semiconductor substrate.

12. A front end tuner as defined in claim 3, wherein said front end tuner is integrated on a semiconductor substrate.

13. A front end tuner as defined in claim 12, wherein said semiconductor substrate comprises silicon and germanium.
